(19) United States
(12) Patent Application Publication
(10) Pub. No.: US 2018/0207727 A1
(43) Pub. Date: Jul. 26, 2018

(54) METHOD AND DEVICE FOR FORMING A CUT-OUT

(71) Applicant: HOMAG GmbH, Schopfloch (DE)

(72) Inventor: Axel PETRAK, Nagold (DE)

(21) Appl. No.: 15/744,024

(22) PCT Filed: Jul. 19, 2016
(86) PCT No.: PCT/EP2016/067150

§ 371 Date: Jan. 11, 2018

(30) Foreign Application Priority Data
Jul. 20, 2015 (DE) 10 2015 213 585.3

(51) Int. Cl. B22F 5/12; B23B 51/10; B27F 1/02; B27M 3/18

(52) U.S. Cl. CPC B22F 5/12; B23B 51/102; F16B 5/0032; B27M 3/18; B27F 1/02

(57) ABSTRACT

The invention relates to a method for forming an elongate cut-out (2), which has a varying transverse dimension in the longitudinal direction, in a workpiece (1), which is preferably composed of wood, wood materials, plastic, or the like at least in some segments, wherein the method comprises plunging a machining device into the workpiece (I), which machining device has an adjustable machining diameter; moving the machining device and the workpiece in relation to each other (II); adjusting the machining diameter of the machining device (III); and removing the machining device from the workpiece (IV).

### TECHNICAL FIELD

The present invention relates to a method for forming an elongate cut-out, which has a varying transverse dimension in the longitudinal direction, in a workpiece, which is preferably composed of wood, wood materials, plastic, or the like, at least in some segments. The invention further relates to a device for executing this method. The field of application of such a device and/or such a method is primarily in the furniture and building element industry.

### PRIOR ART

In the furniture-making industry, forming cut-outs in individual furniture components is a common manufacturing step. Such cut-outs are required, for example, to provide arrangements for connecting different furniture components.

The new connecting system has recently been developed to simplify the assembly of different furniture components. In this connecting system, one of the components to be joined has an attachment plate that is spaced from the component by a pin, said attachment plate being brought into engagement with an undercut cut-out of the other component that is to be joined. In order to insert the attachment plate into the undercut part of the cut-out, the cut-out is formed with an elongated shape with a transverse dimension that increases in the longitudinal direction. The attachment plate is introduced into the cut-out at the end with the larger transverse dimension and moved along the cut-out to the other undercut end, in order to bring the attachment plate into engagement with the undercut and join the two furniture components together.

A method in which a first circular hole is milled at one end of the cut-out with a first milling tool and a second circular hole is milled at the other end of the cut-out with a second milling tool is known for forming the elongate cut-out with varying transverse dimension in the longitudinal direction. In this instance, the second milling tool has a larger machining diameter than the first milling tool. The intermediate space of the cut-out between the first and the second circular hole is milled out using a third milling tool. The third milling tool has a smaller machining diameter than the first and second milling tool and runs over a plurality of trajectories lying one behind the other in the transverse direction of the cut-out, in order to form the cut-out with an increasing transverse dimension between the first and second circular hole.

Due to the large number of individual machining steps, the method known from the prior art for forming an elongate cut-out, which has a transverse dimension that varies in the longitudinal direction, is associated with high costs and the risk of high discard rates.

### OUTLINE OF THE INVENTION

The object of the present invention is therefore to provide a time-saving and cost-efficient method with a low error rate for forming an elongate cut-out in a workpiece, which is preferably composed of wood, wood materials (for example particle board, fibreboard, etc.), plastic, or the like, at least in some segments, said cut-out having a varying transverse dimension in the longitudinal direction. A further object of the present invention is to provide a device for executing this method.

The invention is based on the idea that the high costs and high discard rates of the prior art method are primarily due to the fact that said method necessitates a number of different tools and complex machining trajectories for the third milling tool.

The present invention makes use of this insight and provides a method in accordance with Claim 1 to solve the stated problems. The method according to the invention for forming an elongate cut-out, which has a varying transverse dimension in the longitudinal direction, in a workpiece, which is preferably composed of wood, wood materials, plastic, or the like, at least in some segments, comprises plunging a machining device, in particular a machining tool of the machining device, into the workpiece, wherein said machining device has an adjustable machining diameter; moving the machining device and the workpiece in relation to each other; adjusting the machining diameter of the machining device; and removing the machining device from the workpiece. The machining device preferably comprises a machining tool. Said tool can be a milling tool, for example. The machining device exhibits an adjustable machining or cutting circle diameter. This can be achieved, for example, by adjusting the distance of the machining tool from the rotational axis of the machining device. Other configurations are, of course, also possible.

The said relative movement can be a movement of the machining device (where the workpiece is fixed) or a movement of the workpiece (where the machining device is held or arranged so as to be stationary). The machining device and the workpiece can also be moved simultaneously in order to bring about the said relative movement.

In the context of the invention, the workpieces for machining are primarily sheet-like workpieces. Purely by way of an example, these can be furniture fronts, furniture carcasses, shelves or similar. The invention can also be used for machining workpieces that are sheet-like in sections and/or partially or entirely curved.

The method according to the invention does not require any tool change or any complex trajectories to form an elongate cut-out with varying transverse dimension in the longitudinal direction of the cut-out. Rather, the elongate cut-out is formed by just one machining device. Moreover, the machining device and workpiece only need to be moved along a straight line to form the elongate cut-out with varying transverse dimension. This makes for a time-saving and cost-efficient method with a low error rate.

Furthermore, once the cut-out has been made through the thickness of the workpiece, at least one groove or slot can be created in sections.

According to a preferred embodiment, the previously mentioned relative movement can be linear from the point at which the device is plunged in to the point where it is removed. In particular, either the machining device or the workpiece is moved in a straight line. Simultaneous movement of the machining device and the workpiece is also possible. This serves to keep the work sequences particularly simple.

In one embodiment, the depth of the cut-out in the workpiece is less than the thickness of the workpiece, wherein the depth of the cut-out is notably constant. In particular, the cut-out is an elongated blind hole. Thus the cut-out used for a connection is not visible on the opposite side of the workpiece and allows two workpieces to be joined in a visually appealing—invisible—manner.

The process steps can be executed in the previously listed order. This results in particularly short machining times and in particularly low costs, since the elongate cut-out with varying transverse dimension in the longitudinal direction can be formed in one machining pass.

The machining diameter can be adjusted during the relative movement of machining device and workpiece. In particular, the adjustment takes place during the entire relative movement. Superimposing the movements in this way provides a method with a particularly low manufacturing time. This results in particularly low unit costs.

In a preferred embodiment, the workpiece is conveyed using a conveying device in a conveying direction, wherein the machining device is arranged in a fixed position in the conveying direction. Consequently, the relative movement between machining device and workpiece is provoked by the conveying device. This preferred embodiment makes for particularly high throughput volumes and consequently particularly low unit costs.

The elongate cut-out can have a transverse dimension that increases from one end to the other. For this, the machining or cutting circle diameter can be adjusted so that an elongate cut-out of this type is formed. A method is thus provided for making the new connecting system mentioned in the introduction, which has the corresponding advantages.

Moreover, the machining diameter of the machining device is preferably reduced after the relative movement between machining device and workpiece and before the machining device is removed from the workpiece. This makes for high machining quality, since there is no contact between machining device and workpiece during the removal process.

Before the device is removed, the machining diameter can be adjusted to the machining diameter on insertion. This allows subsequent insertion into the following workpiece without adjustments having to be made to the machining device. In turn this makes it possible to manufacture in a run-through process with a short interval between workpieces, so that a high productivity rate can be achieved.

It is further preferred that, after the machining device has been removed from the workpiece, a machining device is introduced into the cut-out in order to make a groove into the side wall of the cut-out, at least in sections. This can be done using the machining device that has also formed the elongate cut-out or alternatively an additional machining device. If the same machining device is used, this can have an additional machining tool for forming the groove. Alternatively, the groove can also be formed by the machining tool which formed the elongate cut-out. To do this, the machining device can be run along the side wall of the cut-out and create a groove that is limited in the depth direction of the cut-out. This can be used for interlocking with a further component in the cut-out.

In a further embodiment, the machining diameter of the machining device is continuously adjusted during the relative movement between machining device and workpiece. In this case the speed of the adjusting movement is coordinated in particular with the relative movement between machining device and workpiece. This facilitates control of the method.

According to a further objective, the present invention provides an apparatus for executing one of the previously described methods, said apparatus comprising a machining device, which has an adjustable machining diameter, and a controller that is configured to execute one of the previously described methods. Preferably the apparatus further comprises a conveying device for conveying the workpiece in the conveying direction, wherein the machining device is arranged in a fixed position in the conveying direction.

As regards the advantages of the apparatus according to the invention, you are referred to the advantages of the previously described method.

### BRIEF DESCRIPTION OF THE DRAWINGS

FIG. 1 is a side view of a workpiece with an elongate cut-out, which has a varying transverse dimension in the longitudinal direction, that was formed using a method of a first preferred embodiment of the present invention.

FIG. 2 is a diagram to explain the method of the first preferred embodiment of the present invention, with which the elongate cut-out from FIG. 1 is formed.

FIG. 3 is a side view of a workpiece with an elongate cut-out, which has a varying transverse dimension in the longitudinal direction, that was formed using a method of a second preferred embodiment of the present invention.

FIG. 4 shows a cross-sectional view through a workpiece to explain a third preferred embodiment of the present invention.

### DETAILED DESCRIPTION OF THE INVENTION

Preferred embodiments of the present invention are described below, with reference to the accompanying drawings.

The preferred embodiments relate to a method for forming an elongate cut-out 2, which has a varying transverse dimension in the longitudinal direction, in a workpiece 1. The workpiece 1 is preferably composed of wood, wood materials, plastic or the like, at least in some segments. Workpieces of this kind are used, for example, in the furniture and construction element industry. These can be solid wood or particle board, lightweight building board, layered board or the like. However, the present invention is not restricted to such workpieces.

The elongate cut-out 2 to be formed in the workpiece 1 has a profile wherein the transverse dimension of the cut-out varies from one end 3 to the other end 4 of the cut-out 2 in the longitudinal direction 1. The ends 5, 6 are preferably formed like segments of a circle in the longitudinal direction 1 of the cut-out 2.

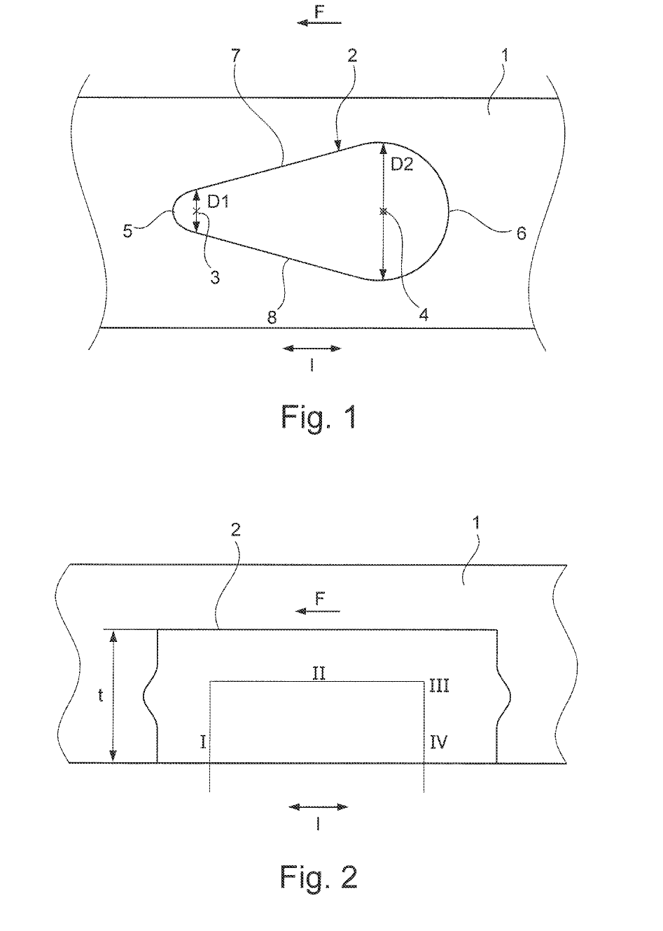

The circle segment 5 at one end 3, which is shown in FIG. 1 and formed with the first preferred embodiment, has a diameter D1. The circle segment 6 at the other end 4, which is formed with the first preferred embodiment, has a diameter D2. The diameter D2 is greater than the diameter D1. Indeed, the diameter D2 can be twice as great as the diameter D1. The circle segments 5, 6 in this cut-out 2 formed with the first preferred embodiment are preferably connected to each other by substantially straight sections 7 and 8.

The elongate cut-out 2 previously described with reference to FIG. 1 is formed using a method of a first preferred embodiment of the present invention, which is described below with reference to FIG. 2.

In order to form the elongate cut-out 2, which exhibits a varying transverse dimension in the longitudinal direction 1, a machining device with a machining tool, in particular a milling tool, which has an adjustable machining or cutting circle diameter, is used. This can be achieved, for example, by providing the machining tool such that it can slide radially on the machining device. In other words, the distance of the machining tool from the rotational axis of the machining device can be adjusted. If this distance is increased, the cutting circle diameter of the machining device is increased. If this distance is reduced, the cutting circle diameter is reduced accordingly. In this way, the machining device can mill holes with different diameters, for example. The adjustment of the machining diameter is preferably continuous, that is to say infinitely variable, and particularly preferably can be done by mechanical means. For example, a machining head for use in machine tools with a main body rotating around a rotational axis and a slide that can slide perpendicular to the rotational axis of the main body, said machining head being capable of being equipped with at least one machining tool, can be used as a machining device.

In a first preferred embodiment, the workpiece 1 is conveyed in a conveying direction F by a conveying device (not shown). The machining device and hence the machining tool are preferably arranged to the side of the conveying device and are adjustable perpendicular to the conveying direction F. In this preferred embodiment the machining device is fixed in place in conveying direction F. It should be pointed out that the machining device is not restricted to this and can also be movable in conveying direction F. In particular, the movement of the machining device can be so controlled in conveying direction F, for example, that the movement in conveying direction F is synchronised with the conveying speed of the conveying device to convey the workpiece 1.

In a first step I for forming the elongate cut-out 2, the machining tool of the machining device is moved perpendicular to the conveying direction F, so that it penetrates into the workpiece 1. The machining tool rotates while it is being plunged in. The conveying device for conveying the workpiece 1 preferably stands while the machining tool is being plunged into the workpiece 1. The machining tool is plunged into the workpiece 1 down to a depth t, which corresponds to the depth of the elongate cut-out 2. In this first step the tool is plunged into the workpiece 1 at a point which corresponds to the subsequent first end 3 of the elongate cut-out 2. The plunging action causes the machining tool to mill a hole with a diameter D1 in the workpiece 1. This hole comprises the circle segment 5 of the elongate cut-out 2.

In a second step II the workpiece 1 is conveyed by the conveying device in conveying direction F. The machining tool continues to rotate during this conveyance. Superimposing the rotational movement of the machining tool and the conveying movement of the conveying device in the conveying direction F results in the formation of an elongate cut-out 2 in the workpiece 1. In this first preferred embodiment, an adjusting movement of the machining diameter of the machining device is superimposed on the conveying movement of the conveying device in conveying direction F and the rotational movement of the machining tool. In particular, the machining diameter is increased during the relative movement between machining device and workpiece 1. The workpiece 1 is conveyed in the conveying direction F and the machining diameter is adjusted until the machining tool reaches the second end 4 of the elongate cut-out 2. At this point the machining diameter is diameter D2. Thus the circle segment 6 is formed at the end 4 of the cut-out 2.

In a third step III, the machining diameter of the machining device is reduced from diameter D2 to diameter D1. For this, the workpiece 1 is preferably standing still in the conveying direction F.

In a fourth step IV, the machining tool is then removed from the workpiece 1 by a movement perpendicular to the conveying direction F. The conveying device then conveys the workpiece 1 onwards in conveying direction F, wherein a new workpiece arrives in the machining area of the machining device and the previously described method can be repeated.

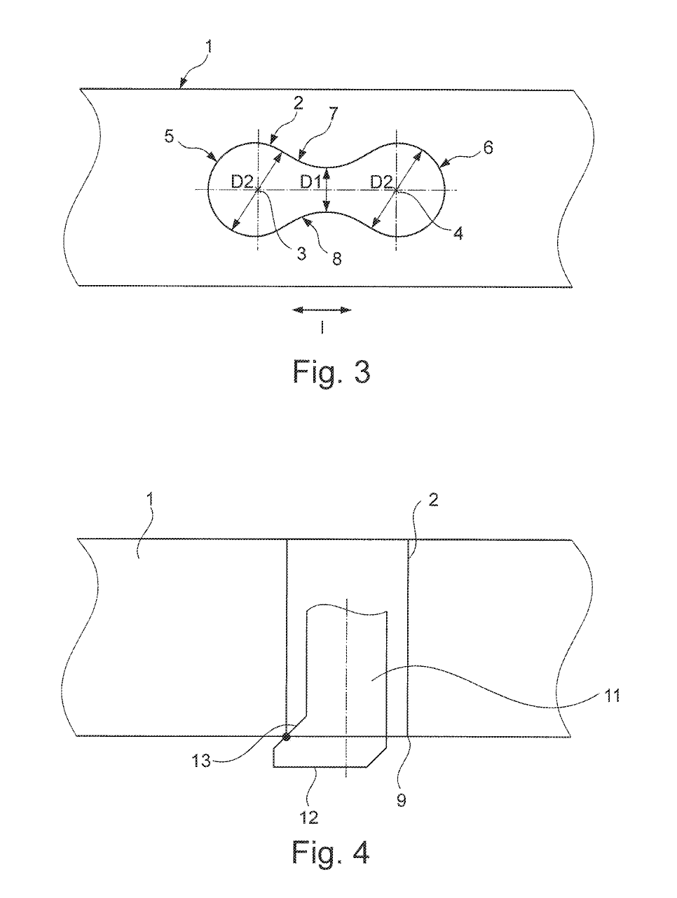

FIG. 3 shows an elongate cut-out 2 that has been formed using a second preferred embodiment of the present invention. With the exception that the profile follows a course transverse to the longitudinal extension of the cut-out 1, this cut-out 2 is the same as the first preferred embodiment. Here we will only mention the differences. In contrast to the cut-out formed with the first preferred embodiment, this cut-out 2 formed with the second preferred embodiment does not have a continuously increasing transverse dimension in the longitudinal direction 1. The cut-out 2 has a transverse dimension D2 at both ends 3 and 4, said dimension preferably being twice as great as the transverse dimension D1 in the centre of the cut-out 2. The consequence of this is that the circle segments 5 and 6 are not connected to each other by substantially straight sections but by arcuate, especially parabolic, sections 7 and 8.

In order to form the elongate cut-out 2 shown in FIG. 3, the method described with reference to FIG. 2 is modified in such a way that the machining tool with the diameter D2 is plunged into the workpiece 1 in step I. In step II, the machining diameter of the machining device is preferably continuously reduced to diameter D1 and subsequently continuously increased to diameter D2. The speed of the diameter adjustment during this process is preferably such that the diameter D1 prevails in the centre, when viewed in the longitudinal direction 1, of the elongate cut-out 2 to be formed. The speed of diameter reduction from diameter D2 to diameter D1 is preferably the same as the speed of the subsequent increase in diameter from diameter D1 to diameter D2. Steps III and IV are the same as those of the first preferred embodiment.

FIG. 4 shows a third preferred embodiment of the present invention. This third preferred embodiment resembles the first or second preferred embodiment except for the differences described below. As described with reference to FIGS. 1 and 2, in this method the elongate cut-out 2 is formed to a depth tin the workpiece 1. As can be seen from FIG. 4, it is also alternatively possible to form the cut-out 2 in such a way that it extends through the full thickness of the workpiece 1. In particular, the back side 9 of the cut-out 2 can be provided with a chamfer in this case.

As shown in FIG. 4, the machining tool 11 of the machining device preferably has a first cutting edge 12 and a second cutting edge 13 for this purpose. The first cutting edge 12 is preferably provided on the front of the tool 11. The second cutting edge 13 is preferably arranged so that it is set back from the first cutting edge 12 in the longitudinal direction of the tool 11. The second cutting edge 13 can be formed with an angle, for example a 45° angle, relative to the first cutting edge 12.

In order to form the elongate cut-out 2 with chamfer, the cut-out 2 can first of all be milled with the first cutting edge 12 of the tool 11 of the machining device. In this case both the first 12 and the second cutting edge 13 are preferably taken right through the workpiece 1. The cutting circle diameter of the machining device is then increased and the machining tool 11 moved back to the workpiece 1. This brings the second cutting edge 13 in contact with the back side 9 of the cut-out 2 to form the chamfer.

1. Method for forming an elongate cut-out (2), which has a varying transverse dimension in the longitudinal direction (1), in a workpiece (1), which is preferably composed of wood, wood materials, plastic, or the like, at least in some segments, comprising the steps:
Plunging a machining device into the workpiece (1), wherein the machining device has an adjustable machining diameter (D1; D2);
Moving the machining device and the workpiece (1) in relation to each other;
Adjusting the machining diameter (D1; D2) of the machining device;
Removing the machining device from the workpiece (1).

2. Method according to claim 1, wherein the relative movement is linear, from plunging in to removing.

3. Method according to any of the preceding claims, wherein the depth of the cut-out in the workpiece is smaller than the thickness of the workpiece, the depth of the cut-out being notably constant.

4. Method according to any of claims 1 to 3, wherein the cut-out (2) extends right through the workpiece (1).

5. Method according to any of the preceding claims, wherein the adjustment of the machining diameter (D1; D2) takes place during the relative movement, in particular during the entire relative movement between machining device and workpiece (1).

6. Method according to any of the preceding claims, wherein the workpiece (1) is conveyed by a conveying device in a conveying direction (F) and the machining device is fixed in place in conveying direction (F).

7. Method according to any of the preceding claims, wherein the machining diameter (D1; D2) is adjusted such that an elongate cut-out (2) is formed with a transverse dimension that increases from one end (3) of the cut-out (2) to the other end (4) of said cut-out (2).

8. Method according to any of the preceding claims, wherein the machining diameter (D1; D2) of the machining device is reduced after the relative movement between machining device and workpiece and before removal of the machining device.

9. Method according to claim 7 or 8, wherein the machining diameter (D2) is adjusted prior to removal to the machining diameter on insertion (D1).

10. Method according to any of the preceding claims, wherein, following removal of the machining device from the workpiece (1), a machining device is introduced into the cut-out to form a groove in the side wall of the cut-out, at least in sections.

11. Method according to any of the preceding claims, wherein the machining diameter (D1; D2) of the machining device is continuously adjusted during the relative movement between machining device and workpiece (1).

12. Apparatus for executing the method according to any of the preceding claims, having a machining device which has an adjustable machining diameter (D1; D2),
a controller that is configured to execute the method according to any of the preceding claims.

13. Apparatus according to claim 12, which further has a conveying device to convey the workpiece (1) in a conveying direction (F), the machining device being fixed in place in conveying direction (F).
